(19) United States
(12) Patent Application Publication
(10) Pub. No.: US 2010/0029154 A1
(43) Pub. Date: Feb. 4, 2010

(54) COMPOSITE REINFORCEMENT OR GEOTEXTILE PRODUCT AND ITS MANUFACTURING PROCESS

(75) Inventors: Jacques Tankere, Meximieux (FR); Jean-Paul Ducol, Lyon (FR)

Correspondence Address: BURR & BROWN, PO BOX 7068, SYRACUSE, NY, 13261-7068, US

(73) Assignee: MDB Texinov SA, Saint Didier de La Tour (FR)

(21) Appl. No.: 12/531,562

(22) PCT Filed: Jul. 3, 2007
(86) PCT No.: PCT/FR2007/051589

§ 371 Date: Sep. 16, 2009

(30) Foreign Application Priority Data
Jul. 4, 2006 (FR) 0652787

(51) Int. Cl. B32B 13/14; D04B 21/00; D04B 21/10

(52) U.S. Cl. 442/42; 66/195; 66/202

(57) ABSTRACT

A composite geotextile or construction product for reinforcing a stratum of concrete or of bitumen comprises at least one reinforcing grid consisting of yarns which are mechanically strong in the warp and/or weft directions. It further comprises at least one layer of an openwork textile produced by weaving or knitting, the openwork textile having openings that are smaller than those of the meshes of the grid, the openwork textile being knitted with the grid by means of at least one knitting yarn, in order to obtain a substantial miscibility of the concrete or the bitumen in the composite textile product.

### FIELD OF THE INVENTION

The present invention relates to a composite geotextile product, comprising a plurality of joined textile layers, suitable for reinforcing a stratum of bitumen or of concrete. Furthermore, the present invention relates to a method for producing such a composite geotextile product.

The subject matter of the invention therefore relates to the field of geotextiles and construction materials.

### PRIOR ART

In a manner known per se, it is necessary to reinforce a stratum of bitumen or concrete using a composite geotextile product forming a reinforcement suitable for absorbing the mechanical stresses which are applied to the bitumen or concrete stratum. Such a reinforcement thereby serves to increase the service life of the stratum of bitumen or concrete, by limiting its cracking. Moreover, such a geotextile product serves to promote the adhesion of such a bitumen stratum to the ground or to maintain the cohesion of a concrete structure.

To prepare such a reinforcement, the prior art teaches geotextile products formed by a reinforcing grid positioned under the stratum of material to be reinforced. Such a grid simply consists of yarns that are mechanically strong in one or the other of their main directions, and in particular based on glass fibres or high tenacity yarns. Extruded drawn grids also exist, in particular made from polypropylene or polyethylene.

Nevertheless, the addition of a single reinforcing grid to the stratum of bitumen or concrete to be reinforced is unsatisfactory in terms of mechanical strength and adhesion of the stratum. In actual fact, the area of the interface between the grid and the stratum to be reinforced is insufficient to absorb the mechanical stresses and to promote a good affinity with the material.

This is why the geotextile products of the prior art generally comprise an additional layer joined to the reinforcing grid. In the prior art, the additional layer generally consists of a nonwoven material. Such an additional layer is generally joined to the reinforcing grid by means of an adhesive bond or by heat-setting at many contact points between the grid and the additional layer.

However, such composite geotextile products have drawbacks such that they do not satisfactorily perform their reinforcement and adhesion functions. This is especially true when the geotextile product must be installed or must operate in difficult environmental conditions, such as a high temperature or humidity, in the presence of abrasive soils and/or high mechanical loads exerted on the bitumen or concrete stratum. In particular, the presence of rainwater on the worksite makes the installation of the stratum very difficult, because of the need to prevent the formation of vapour bubbles during the laying of the hot bitumen. The workers must accordingly wait for the ground to dry, or even to dry it with a blowtorch.

Furthermore, the joining of the reinforcing grid to the additional layer by means of an adhesive bond or by thermofusing has proved to be too fragile to withstand the high mechanical loads that are liable to be applied to the bitumen or concrete stratum, whether by shear, tensile or other loads. Thus, in the presence of such stresses, the adhesive points may be broken, causing the detachment of the grid and of the additional layer or the possible formation of folds, and hence the failure of the composite geotextile product, and therefore the deterioration of the stratum.

In addition, it is also necessary to ensure the compatibility of the adhesives used with regard to the stresses associated with the temperature (in particular in the case of bitumen reinforcement) and the chemical environment, and for example the pH, thereby significantly reducing the choice of the manufacturer.

Moreover, the structure of the material constituting the additional layer, in particular produced of a nonwoven material, prevents an optimal impregnation of the geotextile product within the bitumen or concrete stratum. In fact, the openings of such an additional layer do not permit the passage of a bitumen or of a concrete having a high or even medium viscosity, as is frequently the case.

In consequence, it proves necessary to provide for a perforation of the material constituting the additional layer. However, such an operation represents an extra cost that is commensurate with the area to be treated. Moreover, these holes diminish the mechanical strength of the additional layer, even if they are small and/or few in number.

Furthermore, an additional layer of nonwoven material has a relatively high basis weight, making the composite geotextile product heavier. In fact, the transport, storage and use of such a geotextile product prove to be meticulous.

It is therefore the object of the present invention to propose a geotextile or reinforcing product of composite construction material of which the additional layer is perfectly bonded to the reinforcing grid, and which does not prevent the passage of the material to be reinforced, so that the cost and basis weight will not be too high.

### SUMMARY OF THE INVENTION

The present invention relates to a composite geotextile or reinforcing product suitable for reinforcing a stratum of materials such as concrete or bitumen, of which the reinforcing grid and the additional layer are capable of withstanding high mechanical stresses, while allowing an impregnation or substantial miscibility with the material to be reinforced, for a reasonable cost and basis weight.

The present invention therefore relates to a composite geotextile product for reinforcing a stratum of concrete or of bitumen, comprising at least one reinforcing grid consisting of yarns which are mechanically strong in the warp and/or weft directions.

According to the invention, the composite geotextile product further comprises at least one layer of an openwork textile produced by weaving or knitting, the openwork textile having openings which are smaller than those of the meshes of the grid, this openwork textile being knitted with the grid by means of binding yarns, in order to permit a substantial miscibility of the concrete or the bitumen in the composite geotextile product.

In other words, the additional layer is formed by a textile, whereof the yarns are sufficiently spaced and mutually joined to promote the impregnation by the material of the stratum, while withstanding the mechanical stresses applied to this stratum. Moreover, with a woven or knitted textile, the openings are dimensioned and juxtaposed uniformly, giving rise to a controlled porosity, which guarantees the uniformity of adhesion of the material of the stratum to the grid and the openwork textile, thereby favouring the integration of this openwork textile layer in the concrete or the bitumen, facilitating the evaporation of the water which these materials contain. In fact, in the absence of irregularities, no weak point can be formed, contrary to the composite geotextile products of the prior art.

In the context of the present invention, “miscibility”, as opposed to the common acceptance, means the capacity of the material of the stratum to embed the geotextile or the reinforcement, even if the materials are not mixed, because the materials may continue to exist independently of each other.

In practice, the width and/or length of the meshes of the openwork textile may be between 0.1 mm and 3 or even 10 mm, and advantageously 0.85 mm. Furthermore, the width and/or length of the meshes of the grid is between 10 mm and 100 mm, and advantageously 25 mm.

Such dimensions allow for an optimal miscibility in the composite textile product of relatively viscous materials, such as concrete or bitumen.

In practical terms, the openwork textile consists of yarns of which the size may be between 8 dtex and 200 dtex, and advantageously 22 dtex, the basis weight of the openwork textile being between 8 g/m² and 100 g/m², and advantageously 17 g/m². Such a geotextile product is thus relatively light, which proves to be advantageous for its transport, storage and installation on site.

According to a particular embodiment of the invention, the materials constituting the reinforcing grid and the openwork textile have a melting point higher than the temperature of use of a stratum of bitumen, or about 170 to 230° C.

Whereas the reinforcing grid does not melt when covered with heated materials (bitumen or resin), thereby preserving its mechanical properties necessary for the reinforcement of the stratum, the openwork textile performs the function of improving the “miscibility” with the matrix and the final cohesion obtained. This openwork textile may in certain cases perform the function at the time of use, for example promoting the removal of the moisture present or even causing a chemical reaction via the composition of a specific fibre or a suitable coating, and thereby be virtually removed upon completion of this use.

In practice, the grid may consist of a material selected from the group comprising polyester, polypropylene, high modulus polyethylene, polyvinyl acetate, glass fibres, basalt fibres, aramid fibres. This material is selected to adapt to the pH of the matrix or of its use.

Such materials have mechanical strength and chemical resistance properties that qualify them to reinforce a stratum of bitumen or concrete or resin.

In practical terms, the openwork textile consists of a material selected from the group comprising polyester, polyamide, polypropylene, glass fibres, basalt fibres, aramid fibres, or optionally a fibre or coating allowing a chemical cohesion reaction.

Such materials have mechanical strength and chemical resistance properties that qualify them to reinforce a stratum of bitumen or concrete. They further permit the miscibility, as defined previously in the geotextile product, with adaptation to the chemical medium of the said product, in addition to the pH and temperature conditions.

The openwork textile thus prepared is capable of dissolving after having promoted the use of the geotextile product or of the composite reinforcement. Thus, the textile yarns constituting it are soluble or thermofusible at a predefined temperature, in the concrete or the bitumen constituting the stratum to be reinforced.

In practice, the binding yarns may consist of a material selected from the group comprising polyester, polyamide, polypropylene, high modulus polyethylene, polyvinyl acetate, glass or basalt fibres, aramid fibres or similar, such as sold under the trademark NOMEX®.

Such a yarn is thus suitable for withstanding the mechanical and chemical stresses undergone by the product during its use.

According to a particular embodiment of the invention, the geotextile product further comprises a second layer of openwork textile produced by weaving or knitting, this second layer having openings that are smaller than those of the openings of the layer of openwork textile.

Furthermore, the present invention relates to a method for preparing a geotextile product or composite reinforcement for reinforcing a stratum of concrete or bitumen. According to the invention, this method consists in:
knitting a reinforcing grid consisting of yarns which are mechanically strong in the warp and/or weft directions;
weaving or knitting an openwork textile having openings that are smaller than those of the meshes of the said grid;
knitting the said openwork textile with the reinforcing grid by means of binding yarns.

In other words, the reinforcing grid and the openwork textile are joined together by knitting.

According to a practical particular embodiment of the invention, two or three of these steps of the method are carried out simultaneously.

Such a feature allows rapid, therefore economical fabrication, of the composite geotextile product of the present invention.

Such a knitting serves to confer high mechanical strength on the composite geotextile product.

In the particular case of the production of a composite reinforcement for reinforcing a bitumen stratum, the method further comprises a step of impregnation or coating of the said reinforcement with a bituminous solution.

This impregnation or coating step is carried out in line, thereby promoting the finish of the product in terms of uniformity, dimensions, straight-grain geometry, due to the absence of any rehandling step.

It also serves to confer a degree of stiffness on the product or the reinforcement, facilitating its use on the worksite. It also favours the integration of the material in the final complex, thereby serving to optimise the performance thereof.

### BRIEF DESCRIPTION OF THE DRAWINGS

The present invention and the advantages thereof will also appear from a reading of the description that follows, in conjunction with the drawings which show exemplary and non-limiting embodiments of the invention.

FIG. 1 is a schematic representation of a front view of a geotextile or reinforcement product according to the invention.

FIG. 2 is a schematic representation of a cross section of the same product.

FIG. 3 is a schematic representation of a front view of the use of the same product in civil engineering or building application.

FIG. 4 is a schematic representation of a cross section of the preparation method according to the invention.

FIG. 5 is a schematic representation of a cross section of an application of a reinforcing product according to the invention for a construction material.

FIG. 6 is a schematic representation of a front view of a geotextile or reinforcing product according to a particular embodiment of the invention.

### EMBODIMENT OF THE INVENTION

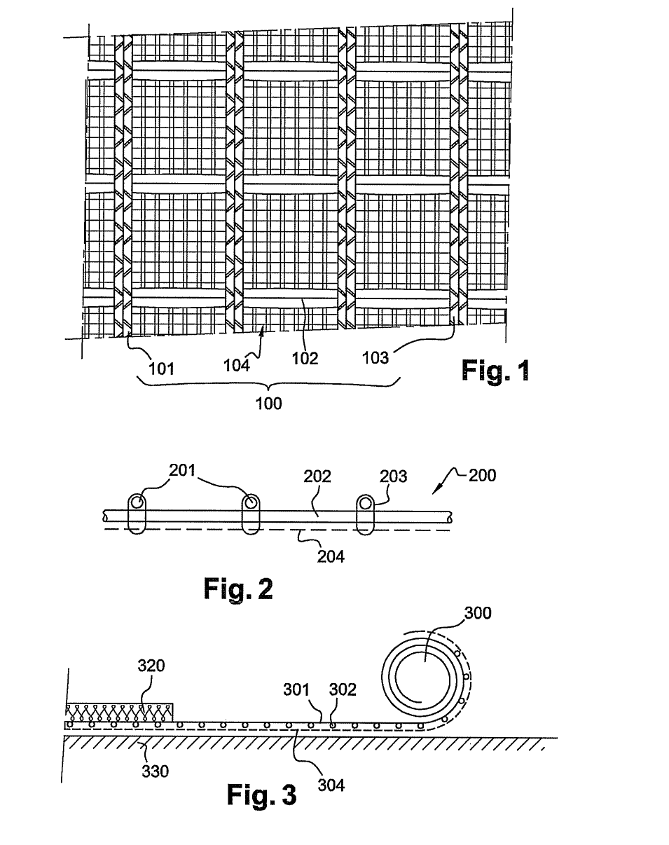

FIG. 1 shows a composite geotextile product 100 comprising a reinforcing grid consisting of yarns 101, 102 extending along the warp 101 and weft 102 directions. According to the invention, the yarns 101 and 102 have mechanical properties such as to make them suitable to withstand the stresses normally undergone by a stratum of material of concrete or bitumen. In fact, when the composite geotextile product is substantially impregnated with such a material, it must absorb the mechanical stresses that this material transmits thereto.

Typically, the yarns 101, 102 constituting the reinforcing grid consist of high strength, high tensile modulus technical yarns, automatically having a low elongation. Moreover, these yarns have a low shrinkage under the action of temperature when subjected to the heat of the bituminous solution.

The yarns 101 and 102 of the reinforcing grid consist here of the same material, in this case glass yarn commonly called “rovings”.

The meshes of the reinforcing grid here have a square shape with approximately 25 mm sides. Obviously, the size and geometry of these meshes can be adapted to the purpose of the geotextile product or the reinforcement.

According to the invention, the composite geotextile product 100 further comprises an additional layer consisting of an openwork textile 104. In this case, the openwork textile 104 is made by knitting from polyester yarns, a material that is thermally sufficiently strong to withstand the high temperature to which the bitumen may be heated during its use.

The openwork textile 104 is thus knitted in order to have meshes of about 0.85 mm. Such openings, whose dimensions are smaller than those of the meshes of the grid (25 mm), allow the passage of relatively viscous materials, such as concrete or bitumen. Thus, during their deposition, such construction materials can embed the composite textile product 100. The latter in fact has a substantial miscibility with such materials, thanks to the openings of the openwork textile 104.

Moreover, the openings of the composite geotextile product 100 allow the removal of the vapour bubbles liable to be formed during the deposition of the bitumen. On the contrary, with the composite geotextile products of the prior art, these vapour bubbles are liable to remain imprisoned, thereby limiting the strength of the bitumen stratum, and also causing cracks.

To produce the geotextile product 100 shown in FIG. 1, the openwork textile yarns 104 were selected with a density of 22 dtex. In consequence, the basis weight of the openwork textile 104 is about 17 g/m² for the mesh geometry previously described. Such a basis weight, which is particularly light, facilitates the placement of the geotextile product 100, including from large rolls. Moreover, such a linear density confers sufficient fineness and flexibility on the yarns constituting the openwork textile for it to pass directly through the needles of the knitting machine, thereby favouring the complete integration of the said openwork textile with the reinforcing grid.

Obviously, the size of the yarn constituting the openwork textile 104 can be selected to obtain a specific basis weight and mechanical properties for the intended application. Similarly, the materials constituting the openwork textile 104 can be selected from the group comprising polyester, glass fibres, basalt fibres, aramid fibres, or even a technical yarn such as NOMEX® (registered trademark).

Finally, a material that is soluble or thermofusible at a predefined temperature can also be selected for these yarns, to allow the disappearance of the structure after placement, particularly during the use as a reinforcement for a bitumen stratum.

Similarly, the material constituting the yarns 101 and 102 of the reinforcing grid can be selected according to the intended application. Such a material may, for example, be selected from the group comprising polypropylene, polyvinyl acetate, glass fibres, basalt fibres or aramid fibres.

Moreover, it is possible to dimension the openwork textile 104 differently according to the mechanical strength and viscosity of the material to be used. Besides, as may be observed in FIG. 1, there are in fact two different types of meshes juxtaposed in succession, that is a square mesh and a rectangular mesh. It is essential to preserve a good uniformity in the dimensions and juxtaposition of the openings of the openwork textile, which guarantees the uniformity of adhesion between geotextile and stratum, hence the overall strength, besides the integration of the openwork textile in the material, and particularly in the bituminous solution. The linear density, basis weight and shape of the mesh or meshes, are determined in particular by the mechanical stresses to be absorbed.

Thus, the mesh of the openwork textile may also have a hexagonal or rectangular shape or any other shape obtainable on a Raschel machine or a weaving loom according to the adhesion and/or mechanical strength desired for the stratum of construction materials.

According to the invention, the reinforcing grid is knitted with the openwork textile 104 by means of a knitting yarn 103 of polyester. According to a feature of the invention, the knitting of the openwork textile with the grid is carried out using a Raschel machine. Such a knitting serves to ensure high mechanical cohesion between the openwork textile 104 and the yarns 101 and 102 forming the reinforcing grid.

According to a particular embodiment, it is possible to use a knitting machine of the “full-width weft insertion Raschel machine” type, which serves to produce a geotextile product or a composite reinforcement with a high production rate and large width, typically over 5 m, or even 6 m. Such a geotextile product width can be particularly suitable, for example for the construction of roadways, wherein the large width of the geotextile product procures a significant advantage because it allows very rapid installation.

As shown in FIG. 2, the weft yarns 202 are compressed between the warp yarns 201 and the openwork textile 204 by means of a knitting yarn 203. The weft yarns 202 are therefore secured by a simple pressure.

An important advantage of such an openwork textile resides in the uniformity of its openings, contrary to other textiles, such as nonwoven textiles. Thus, the penetration of the bitumen or concrete through the composite geotextile product takes place uniformly, thereby eliminating any weak points of the deposited stratum.

With such openings in the grid and the openwork textile, it is possible to obtain an impregnation or coating by a bituminous substance or other solution which serves to improve its cohesion with the bitumen, concrete or resin stratum to be reinforced, directly in line with the production machine, thereby significantly facilitating the installation on the construction site, because these elements, thus covered, have a good affinity with the matrix of the stratum deposited or of the panel produced.

This impregnation or coating is carried out by devices known to a person skilled in the art, directly installed at the outlet of the knitting machine.

Thus, the risk of loss of adhesion or delamination of the bitumen, concrete or resin stratum may be substantially decreased by the use of the geotextile product of the present invention. Moreover, the miscibility thereof with the strata to be reinforced is significantly increased, thereby increasing the mechanical strength of the stratum to be reinforced insofar as the geotextile product absorbs higher mechanical stresses.

Furthermore, on account of the knitting together of the elements of the composite geotextile product of the invention, the production cost of such product is lower than that of the geotextile products of the prior art, because the number of operations and/or the quantity of adhesive and/or the heat energy required for its fabrication are reduced or eliminated. It is thereby possible to fabricate a composite geotextile product whose tensile strength may vary from 20 kN to 400 kN according to the stresses undergone by the structure to be reinforced.

FIG. 3 shows a step of construction of a bitumen stratum 320 on a pavement or on a floor to be reinforced 330. The geotextile product or the composite reinforcement of the present invention is used here in the form of a roll 300 outspread on the pavement or the floor 330, and then covered or completely impregnated by the bitumen or the resin 320.

In the example in FIG. 3, the openwork textile 304 is positioned against the pavement or the floor 330 to be reinforced, while the reinforcing grid consisting of warp 301 and weft 302 yarns is placed above the openwork textile next to the bituminous layer. In other cases, the reinforcing grid may be placed under the openwork textile.

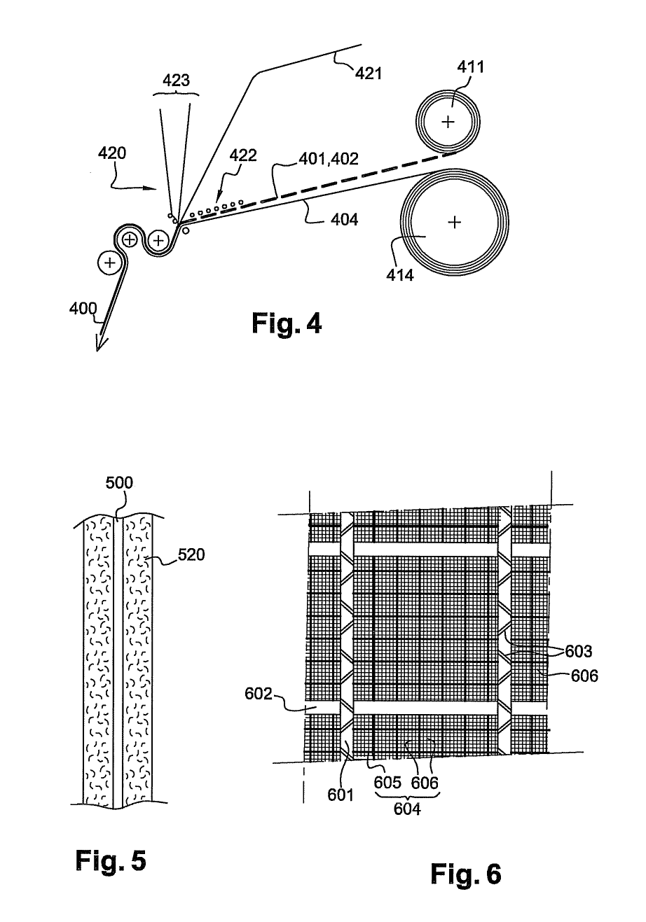

FIG. 4 shows a device for producing the geotextile product according to the invention. The openwork textile 404 issues from a roll 414. It is introduced with the yarns 421 and 422 of the reinforcing grid simultaneously. These elements are joined together by the binding yarns 423, in the knitting members of a Raschel machine. The knitting needles and yarn guides are shown here simply in the region 420 of FIG. 4. This is because the technique of cast-off stitch knitting on a Raschel machine is widely known from the prior art. For this purpose, it is nevertheless necessary to ensure the compatibility of the gauge of the knitting machine while correctly positioning the needles and the yarn guides.

In an alternative, a second textile 411, openwork or not, can be added, which may also be a voile fabric or a paper or synthetic film.

In an alternative, during the same method, the openwork textile 404 is prepared by knitting by means of needles 420, simultaneously with the assembly of the warp and weft yarns 401, 402. The grid and openwork textile combination is simultaneously knitted in order to produce a finished geotextile product or composite reinforcement 400. In this case, the gauge and the arrangement of the knitting members are particularly suitable for obtaining the simultaneity of the geometries and the spacings of the yarns of the reinforcing grid and of the openwork textile. FIG. 6 illustrates this configuration.

It is even possible, by such a direct production method, to produce an openwork textile 604, as shown in FIG. 6, consisting of a first openwork textile 605 having large meshes and a second openwork textile 606 having smaller meshes. Such an openwork textile 604 accordingly has a larger surface exposed to the concrete, bitumen or resin, thereby conferring on the geotextile product or the reinforcement a larger interface for affinity with the stratum and higher mechanical strength.

Furthermore, FIG. 5 shows a composite building reinforcement product 500 according to the invention embedded in a concrete or resin stratum 520. The combination thus forms a prefabricated panel having reinforced mechanical properties. The product 500 may even be prestressed in the matrix 520 that accommodates it, in order to optimize the mechanical properties of the panel thus produced.

1. A composite geotextile or construction product for reinforcing a stratum of concrete or of bitumen, comprising at least one reinforcing grid consisting of yarns which are mechanically strong in the warp and/or weft directions, wherein it further comprises at least one layer of an openwork textile produced by weaving or knitting, the said openwork textile having openings that are smaller than those of the meshes of the said grid, the said openwork textile being knitted with the grid by means of at least one knitting yarn, in order to obtain a substantial miscibility of the concrete or the bitumen in the said composite textile product.

2. The geotextile or construction product according to claim 1, wherein the reinforcing grid consists of a material selected from the group comprising polyester, high modulus polyethylene, polypropylene, polyvinyl acetate, glass fibres, basalt fibres, aramid fibres.

3. The geotextile or construction product according to claim 1, wherein the openwork textile consists of a material selected from the group comprising polyester, glass fibres, basalt fibres, aramid fibres, a polyamide.

4. The geotextile or construction product according to claim 1, wherein the openwork textile consists of a soluble or thermofusible material at a predefined temperature in the concrete or the bitumen constituting the stratum to be reinforced.

5. The geotextile or construction product according to claim 1, wherein the materials constituting the reinforcing grid and the openwork textile have a melting point higher than the temperature of use of a stratum of bitumen, or about 170 to 230° C.

6. The geotextile or construction product according to claim 1, wherein the width and/or length of the meshes of the openwork textile is between 0.1 mm and 10 mm, and advantageously 0.85 mm, and in that the width and/or the length of the meshes of the said grid is between 10 mm and 100 mm, and advantageously 25 mm.

7. The geotextile or construction product according to claim 1, wherein the openwork textile consists of yarns having a size between 8 dtex and 200 dtex, and advantageously 22 dtex, and in that the basis weight of the said openwork textile is between 8 g/m² and 100 g/m², and advantageously 17 g/m².

8. The geotextile or construction product according to claim 1, wherein the knitting yarn consists of a material selected from the group comprising polyester, high modulus polyethylene, polypropylene, polyvinyl acetate, glass fibres, basalt fibres, aramid fibres.

9. The geotextile or construction product according to claim 1, wherein it further comprises a second layer of openwork textile produced by weaving or knitting, the said second layer having openings that are smaller than those of the openings of the layer of openwork textile.

10. A method for producing a composite geotextile or construction product for reinforcing a stratum of concrete or of bitumen, consisting in:
knitting a reinforcing grid consisting of yarns which are mechanically strong in the warp and/or weft directions;
weaving or knitting an openwork textile having openings that are smaller than those of the meshes of the said grid;
knitting the said openwork textile with the reinforcing grid by means of at least one knitting yarn.

11. The method for producing a geotextile or construction product according to claim 10, wherein two or three of the said steps are carried out simultaneously.

12. The method for producing a geotextile or construction product according to either claim 10, wherein the step of knitting of the said openwork textile to the said reinforcing grid is carried out by means of a Raschel machine.

13. The method for producing a composite geotextile or construction product for reinforcing a stratum of bitumen according to claim 10, wherein it further comprises a step of impregnation or coating of the said product by means of a bituminous solution.

14. The method for producing a composite geotextile or construction product for reinforcing a stratum of bitumen according to claim 13, wherein the said impregnation or coating step is carried out in line.
